(19) United States
(12) Patent Application Publication
(10) Pub. No.: US 2010/0327196 A1
(43) Pub. Date: Dec. 30, 2010

(54) Purging Mechanism for a Hemi-Wedge Valve

(75) Inventors: Thomas G. Hill, JR., Conroe, TX (US); William C. Rhinehart, The Woodlands, TX (US)

Correspondence Address: BURLESON COOKE L.L.P., 2040 NORTH LOOP 336 WEST, SUITE 123, CONROE, TX, 77304, US

(73) Assignee: Tejas Research and Engineering, LP, The Woodlands, TX (US)

(21) Appl. No.: 12/495,360

(22) Filed: Jun. 30, 2009

(51) Int. Cl. F16K 31/02; F16K 15/00; F16K 15/04; B08B 3/00

(52) U.S. Cl. 251/129.01; 251/304; 251/315.1; 134/10

(57) ABSTRACT

The present invention is directed to a technique of purging unwanted particles from the interior of a valve body. Inlet and outlet ports are formed in the valve housing to allow for circulation of the fluid within the valve body. The flow path of the fluid is isolated from the main fluid flow path when the valve is in the open or closed position. Additionally the pressure of the fluid is at a level higher than that of the main fluid flow.

### BACKGROUND OF INVENTION

1. Field of the Invention

The present invention relates to ball type or hemi-wedge valves designed for use in pipelines such as those used for conveying oil or gas from wells to other facilities such as storage tanks, production facilities, etc. A hemi-wedge valve is distinguishable from a typical ball type or gate valve in that it employs a curved wedge formed as a tapered section rotatable through the fluid path. In particular this invention is directed to an arrangement for preventing the buildup of foreign material in the interior of a ball or hemi-wedge type valve.

2. Description of Related Art

Different types of valves are known for use in gas and oil pipelines. Typical valves include hemi-wedge valves, ball valves, gate valves, and plug valves. Oil and gas contain different types of contaminates such as black powder. Additionally precipitates often form in gas transmission pipelines after continuous use, especially where ambient temperatures vary widely or where daytime temperatures are hot. The precipitates form a very fine powder whose microscopic particles are very hard. These particles attach to the inner surface of the pipeline.

In order to clean the interior of the pipelines, devices known as pigs are placed in the pipeline and pressurized fluid is used to push the pig (which is a plug that closely engages the wall of the pipeline) along the pipeline to dislodge the particles from the inner surface of the pipe and discharge the particles from the pipeline through outlets spaced along the pipeline. The inlets and outlets for the pigs are isolated from the main transmission pipelines by large valves, such as a ball or gate valve. The above mentioned particles, which are dislodged from the interior surface of the pipeline, work their way into the seals and clearances of the valve, eventually causing it to either malfunction or fail.

### BRIEF SUMMARY OF THE INVENTION

To overcome the buildup of harmful particles in valve bodies as described above, the present invention utilizes a flow of secondary flow through the valve body to purge the particles from sealing surfaces and clearances within the valve body. The fluid is circulated at a pressure greater than that of the main fluid in the pipeline and is isolated from the main flow path in the open and closed positions of the valve. This technique is especially effective when used in conjunction with the three piece valve core design of the hemi wedge valve as will be explained in greater detail below.

### BRIEF DESCRIPTION OF THE SEVERAL VIEWS OF THE DRAWING(S)

FIG. 1 is a top view of a hemi-wedge valve according to the present invention.

FIG. 2 is a top view of a hemi-wedge valve in the closed position.

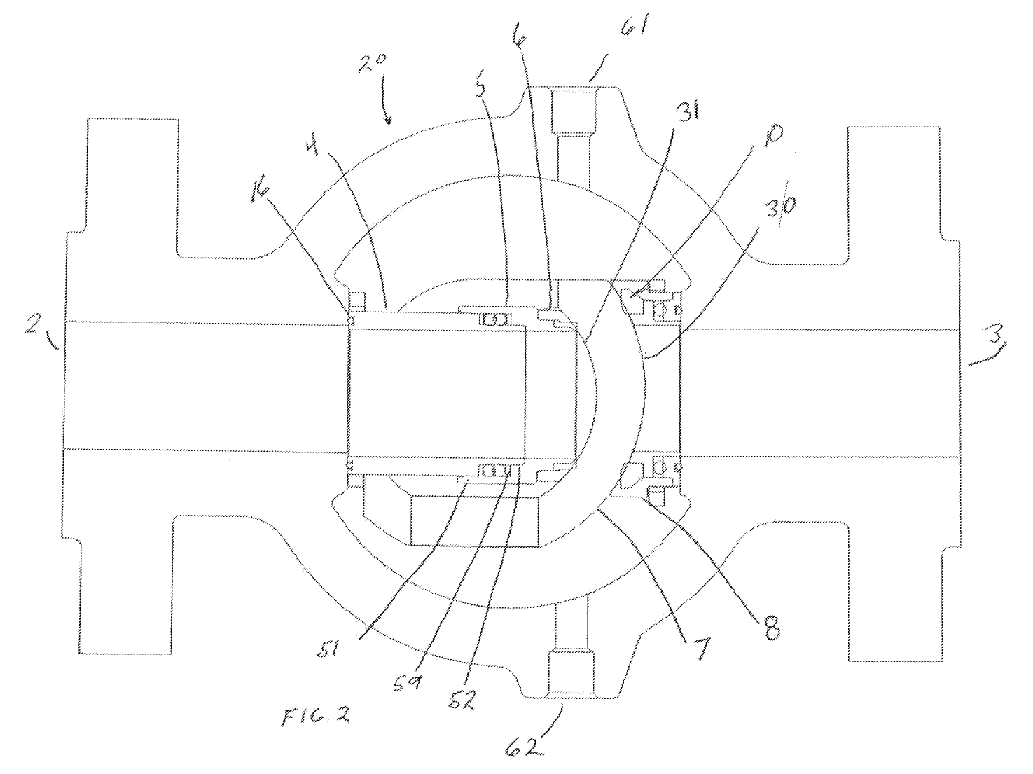

FIG. 3 is a schematic of the valve shown in FIG. 1 placed in a pipeline with supporting equipment.

FIG. 4 is a top view of the invention as applied to a conventional ball valve shown in the open position.

FIG. 5 is a top view of the ball valve of FIG. 4 shown in the closed position.

### DETAILED DESCRIPTION OF THE INVENTION

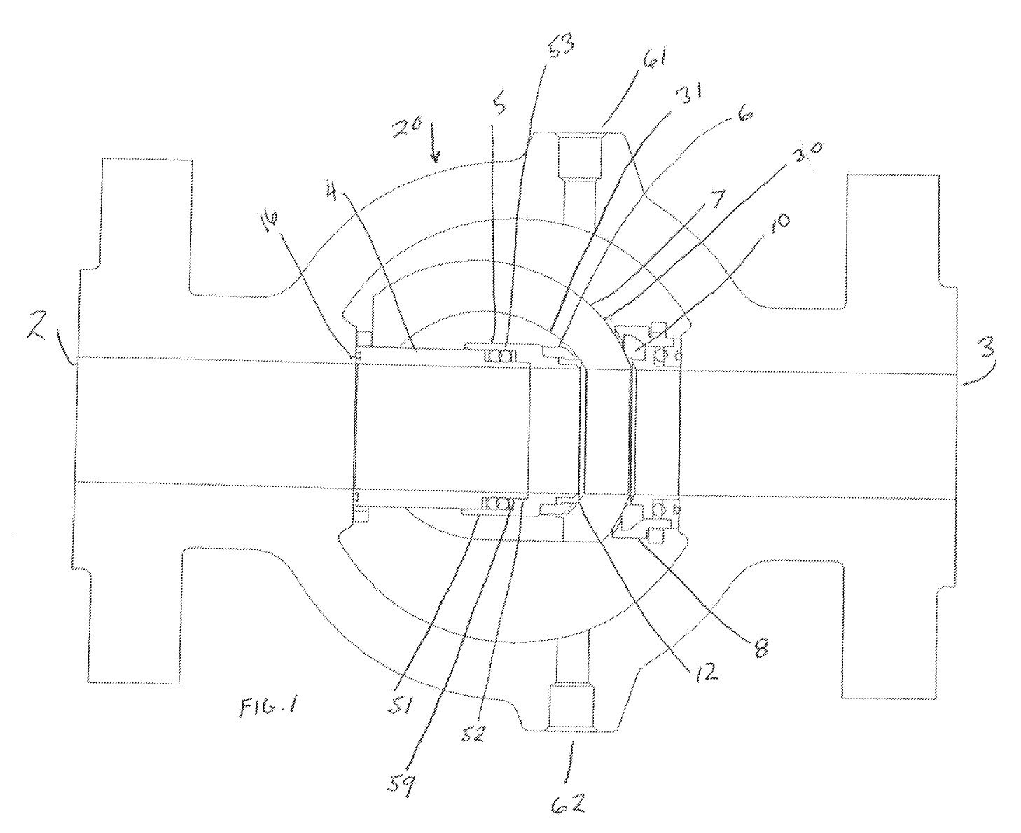

FIG. 1 illustrates a specific embodiment of a hemi-wedge valve to which the invention had been applied. The valve body 20 includes an inlet 2 and outlet 3 for the main fluid flow which is being regulated by the valve. The valve also includes a hemi-wedge valve element 7 which includes an upstream valve surface 31 and a downstream valve surface 30. Valve seat seals are provided at 12 and 10 respectively. The hemi-wedge valve of FIG. 1 has a core member that defines the main fluid flow path through the valve. In this example of a hemi-wedge valve, the valve member includes three portions, 4, 5, and 6. Upstream portion of valve core member 4 includes a seal 16 that engages a surface at the inlet 2. Intermediate valve core member 5 has an outer cylindrical portion 51 that receives a reduced diameter portion 52 of valve core member 4. Valve core member 5 also has a stepped portion 59 that forms a chamber for a seal 53 between valve core members 4 and 5. Valve portion 6 also includes a sealing ring 12.

The downstream surface of hemi-wedge valve member 7 is in sealing contact with seal 10 which is supported by valve seat member 8. A unique feature of a hemi-wedge valve is that the valve member 7 has a thickness that increases from its leading edge to its tailing edge as the valve closes. This in conjunction with the three piece valve core construction as described above, results in a closing force being applied to both sides of the valve member 7.

This design in and of itself tends to minimize the buildup of particulate material in the sealing components of the valve. In addition, in order to prevent buildup of particulate material, the present invention provides for a flow of secondary fluid within the housing of the valve. As shown in FIG. 1, an inlet port 61 for the secondary fluid is formed in the housing and an outlet port 62 is formed in the housing for exit of the secondary fluid from the valve housing. The secondary fluid inlet and outlet may be located anywhere in the housing. As shown, it can be seen that the inlet and outlet secondary fluid ports are isolated from the main fluid flow when the valve is in the open or closed position. Other hemi-wedge valves to which the present invention may be applied are shown and described in U.S. Pat. Nos. 4,962,911 and 7,357,145, the contents of both disclosures being expressly incorporated herein.

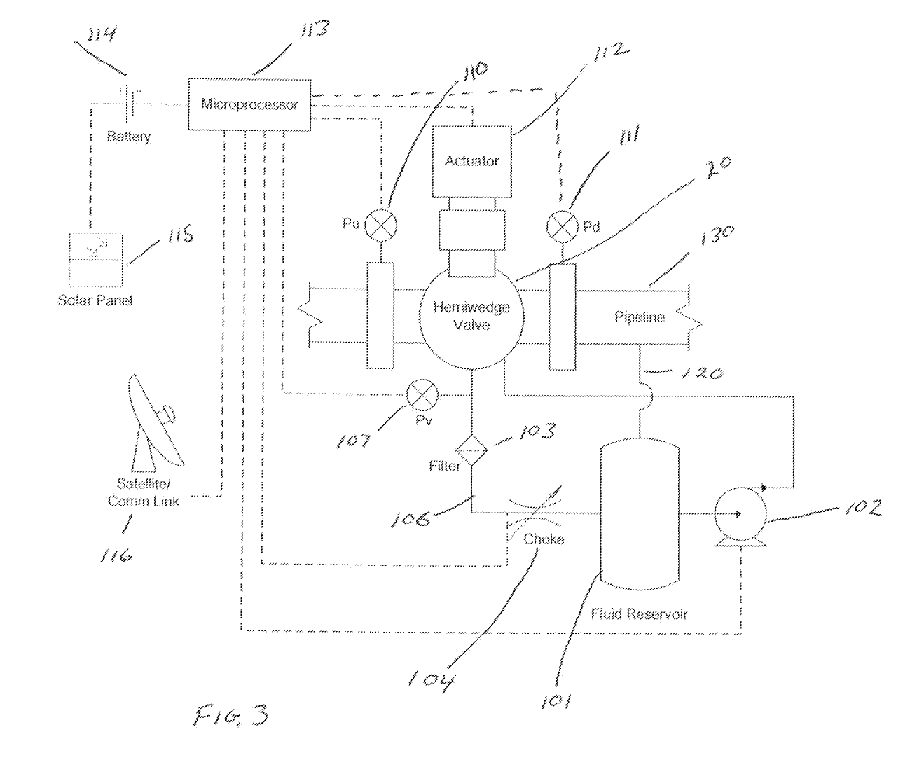

A system for supplying the secondary purging fluid will now be described by reference to FIG. 3. Hemi-wedge valve 20 located in a fluid pipeline 130 as described above. A fluid supply tank 101 is provided. In the embodiment shown, the fluid can be pressurized by a pump 102 connected to inlet port 61. Alternately the fluid tank could be constructed at a higher elevation with respect to the pipeline and a pressure increasing pump provided if needed. Also as a third embodiment, fluid under pressure from the pipeline could be diverted to the upper portion of the purging fluid tank as shown at 120 to pressurize the contents of the tank by exerting a force on a flexible diaphragm or a piston within the tank as is well known in the art. If the fluid in the pipeline is a gas and the purging fluid is a liquid, then the diaphragm or piston would not be needed. A filter 103 and a variable choke valve 104 are also provided in a return conduit 106.

In order to make sure that the pressure of the secondary fluid is greater than that of the fluid in the pipeline, two pressure sensors 110, 111 are provided at the upstream and downstream sections of hemi-wedge valve 20. A third pressure sensor 107 is placed in the return conduit 106. Information from the three sensors is sent to a microprocessor 113. Microprocessor 113 analyzes the information and regulates variable choke valve 104 as necessary to maintain the pressure of the secondary liquid above that in the main flow line. Microprocessor 113 is also used to monitor the position of the valve actuator 112, and to turn pump 102 on and off.

Power for the microprocessor may be provided by conventional land power lines or by a battery 114 that is connected to a charging solar cell 115 as is known in the art. Furthermore the microprocessor may be connected to a satellite link 116 for sending and receiving information and commands as is known in the art.

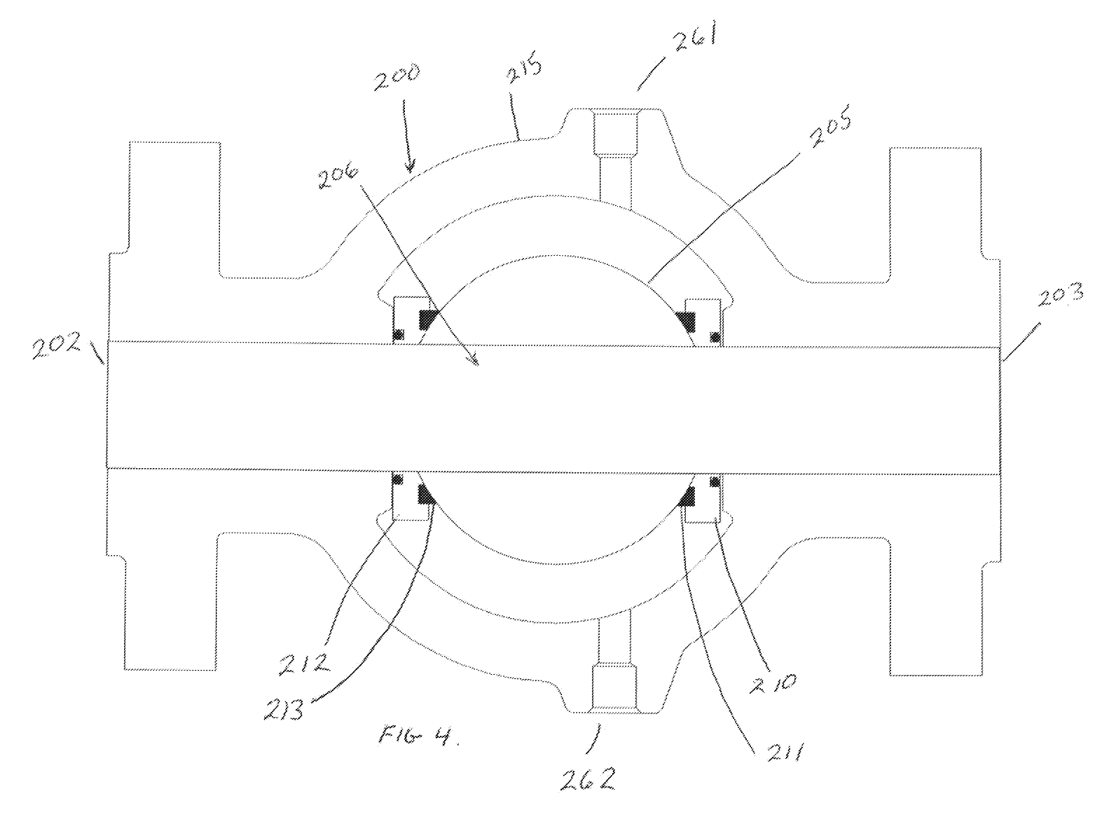

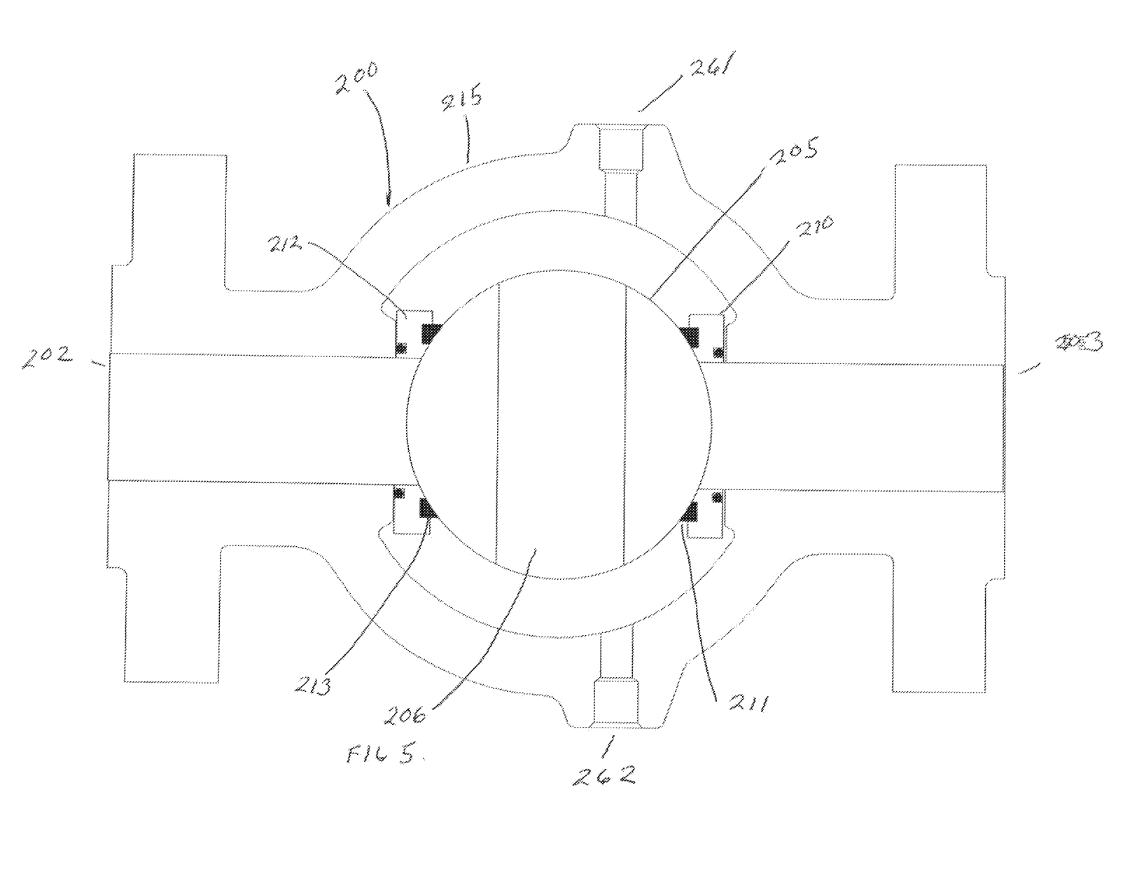

FIGS. 4 and 5 illustrate the invention as applied to a conventional ball valve 200. Ball valve 200 has a main fluid inlet 202 and outlet 203. The ball valve 205 has a central bore 206 to provide a flow path for the main fluid. Valve seats 212 and 210 are provided and include seals 213 and 211 as shown in FIG. 4. Valve 200 includes an inlet 261 and outlet 262 formed in the housing 215 for circulation of a secondary fluid for purging and cleaning of the internal parts of the valve. Ball valve 200 is positioned in a pipeline in the same manner as hemi-wedge valve 20 is positioned as shown in FIG. 3.

Although the present invention has been described with respect to specific details, it is not intended that such details should be regarded as limitations on the scope of the invention, except to the extent that they are included in the accompanying claims.

I claim:

1. A valve comprising:
a housing having a fluid inlet and a fluid outlet;
a main flow path connecting the fluid inlet to the fluid outlet;
a rotatable hemi-wedge valve closure member mounted within the housing;
a valve body core defining a portion of the flow path;
a downstream portion of the valve body core having a first sealing surface;
the upstream portion of the outlet having a second sealing surface; and
the hemi-wedge rotatable between an open position allowing for the unobstructed flow of fluid through the valve and a closed position in which the upstream surface of the hemi-wedge engages the first sealing surface and the downstream surface of the hemi-wedge engages the second sealing surface, a secondary fluid inlet port in the housing for connection to a source of a second fluid under pressure, a secondary fluid outlet port in fluid communication with the secondary fluid inlet port for returning the pressurized secondary fluid to its source, the fluid inlet port and outlet ports being isolated from the main flow path when the valve is in the open or closed position.

2. The valve of claim 1 further including a fluid tank with fluid located therein, a pump connected between the secondary fluid inlet port and the fluid tank, and a return conduit connected between the secondary outlet port and the fluid tank for recirculating the fluid back to the tank.

3. The valve of claim 2 further including a filter and an adjustable choke valve in the return conduit.

4. The valve of claim 2 further including a branch conduit located between the main fluid pipeline and the fluid tank to pressurize the contents of the tank.

5. The valve according to claim 2 further including pressure sensors at the inlet and outlet portions of the valve, a pressure sensor in the return conduit, a microprocessor that receives electrical signals from the pressure sensors, said microprocessor operable to regulate the variable choke valve to maintain the pressure of the secondary fluid higher than the main fluid flowing through the valve.

6. The valve according to claim 6, further including a battery connected to the microprocessor, and a solar panel charging mechanism connected to the battery for recharging the battery.

7. A valve compromising:
a housing having fluid inlet and a fluid outlet;
a main flow path connecting the fluid inlet to the fluid outlet;
a rotatable ball valve closure member mounted within the housing;
the upstream portion of the outlet having a sealing surface; and
the ball valve rotatable between an open position allowing for the unobstructed flow of a fluid through the valve and a closed position;
an inlet port in the housing for connection to a source of a second fluid under pressure, the fluid inlet port being isolated from the flow path when the valve is in the open or closed position; and
a fluid outlet port in fluid communication with the inlet port for returning the second fluid under pressure to its source.

8. A valve comprising:
a housing having a fluid inlet and a fluid outlet;
a main flow path connecting the fluid inlet to the fluid outlet;
a rotatable hemi-wedge valve closure member mounted within the housing;
the upstream portion of the outlet having a sealing surface; the hemi-wedge rotatable between an open position allowing for the unobstructed flow of fluid through the valve and a closed position, fluid inlet port in the housing for connection to a source of a second fluid under pressure, a secondary fluid outlet port in fluid communication with the secondary fluid inlet port for returning the pressurized secondary fluid to its source, the fluid inlet port and outlet ports being isolated from the main flow path when the valve is in the open or closed position.

9. A method of cleaning the interior of a valve body comprising:
forming inlet and outlet ports for a secondary fluid in the valve body;
isolating the inlet and outlet ports from the main fluid flow path when the valve is in the open or closed position;
supplying a fluid to the inlet port at a pressure greater than that of the main fluid; and
returning the fluid to a reservoir tank.
